(19) United States
(12) Patent Application Publication
(10) Pub. No.: US 2003/0161400 A1
(43) Pub. Date: Aug. 28, 2003

(54) Method and system for improved diamond motion search

(76) Inventors: Jonathan J. Dinerstein, Logan, UT (US); Joseph N. Romriell, Mendon, UT (US)

Correspondence Address: TRASK BRITT, P.O. BOX 2550, SALT LAKE CITY, UT, 84110, US

(21) Appl. No.: 10/084,609

(22) Filed: Feb. 27, 2002

(51) Int. Cl. H04N 7/12

(52) U.S. Cl. 375/240.16; 375/240.24; 375/240.01

(57) ABSTRACT

The present invention includes a method and system for improved diamond motion search. A method for diamond motion searching a video frame is disclosed which includes predicting the maximum distance that a macroblock may have moved. This maximum distance provides a maximum range in which to consider searching. This “predicted search range” may be used to make assumptions on whether to expect high motion. If high motion is anticipated, the diamond search may be seeded using a large circular pattern for determining a start location and to avoid becoming lost in local minima and then proceeding with the large diamond pattern for motion searching. A method for compressing motion video images is also disclosed. Additionally, a system for transmitting and receiving video images is disclosed. The system for transmitting and receiving video images may be a video conferencing system.

### CROSS-REFERENCE TO RELATED APPLICATION

This application is related to pending application Ser. No. 10/029,142, filed Dec. 20, 2001, titled METHOD AND SYSTEM FOR IMAGE COMPRESSION USING BLOCK SIZE HEURISTICS, the contents of which are expressly incorporated herein by reference for all purposes.

### FIELD OF THE INVENTION

The present invention relates generally to image compression techniques applicable to motion video. More specifically, the present invention includes a method and system for improved motion searching.

### BACKGROUND OF THE INVENTION

Digital video products and services such as digital satellite service and video streaming over the Internet are becoming increasingly popular and drawing significant attention in the marketplace. Because of limitations in digital signal storage capacity and in network and broadcast bandwidth transmission limitations, there has been a need for compression of digital video signals for efficient storage and transmission of video images. For this reason, many standards for compression and encoding of digital video signals have been developed. For example, the International Telecommunication Union (ITU) has promulgated the H.261, H.263 and H.26L standards for digital video encoding. Additionally, the International Standards Organization (ISO) has promulgated the Motion Picture Experts Group (MPEG) MPEG-1 and MPEG-2 standards for digital video encoding.

These standards specify with particularity the form of encoded digital video signals and how such signals are to be decoded for presentation to a viewer. However, significant discretion is allowed for selecting how digital video signals are transformed from uncompressed format to a compressed, or encoded format. For this reason, there are many different digital video signal encoders available today. These various digital video signal encoders may achieve varying degrees of compression.

It is desirable for a digital video signal encoder to achieve a high degree of compression without significant loss of image quality. Video signal compression is generally achieved by representing identical or similar portions of an image as infrequently as possible to avoid redundancy. A digital motion video image, which may be referred to as a “video stream”, may be organized hierarchically into groups of pictures which includes one or more frames, each of which may represent a single image of a sequence of images of the video stream. All frames may be compressed by reducing the redundancy of image data within a single frame. Motion-compensated frames may be further compressed by reducing redundancy of image data within a sequence of frames.

Motion video compression may be based on the assumption that little change occurs between frames. This is frequently the case for many video signals. This assumption may be used to improve motion video compression because a significant quantity of picture information may be obtained from the previous frame. In this way, only the portions of the picture that have changed need to be stored or transmitted.

Each video frame may include a number of macroblocks that define respective portions of the video image of the video frame. The term macroblock refers to a fundamental unit of pixels, “16×16” in size. A pixel may be a single dot of color in a video picture frame. A picture may be evenly divided into a plurality of macroblocks. For example, if the video resolution for a given picture is 176×144 pixels, then there are 11×9 macroblocks. Other block sizes, i.e., 8×16, 16×8, 8×8, 4×8, 8×4 and 4×4, may be derived by subdividing the fundamental 16×16 macroblock.

Motion in video frames may be the result of objects in consecutive video frames moving relative to the background. A motion search is used to find where items in a given video picture frame have moved from the previous video picture frame. A motion search is performed one macroblock at a time. A motion search is performed on the top left-hand macroblock first and progresses one row of macroblocks at a time, i.e., from left to right one row at a time from top to bottom.

Motion in video frames may also occur when the video sequence includes a camera pan, i.e., a generally uniform spatial displacement of the entirety of the subject matter of the motion video image. In a camera pan, most of the picture information from the previous frame may still be the same, but it may be at a new location in the current picture frame. It is important to know where objects in the current video frame have moved relative to the previous video frame so that as much information can be carried forward from the previous frame as possible to improve compression.

Of course, change in the picture from frame to frame will not only happen because of camera motion. Objects within a video frame can also move, e.g., a stationary camera recording a person who is walking past the frame of view. In cases such as this, it is possible that only small regions of the picture have moved, and other small regions have remained in place. Further, for video content such as sports, it is possible for many small objects to be moving in different directions.

A motion vector may be used in mapping macroblocks from one video frame (the previous frame) to corresponding positions of a temporally displaced video frame (the current frame). A motion vector specifies the motion of a macroblock from the previous frame to the current frame. A motion vector maps a spatial displacement within the temporally displaced frame of a relatively closely correlated macroblock of picture elements, or pixels. In frames in which subject matter is moving, motion vectors representing spatial displacement may identify a corresponding macroblock that matches a previous macroblock rather closely. A motion vector is the result of performing a motion search for a given macroblock. A search to determine where motion has taken place from a previous frame to a current frame may be referred to as “motion estimation”. The terms “motion estimation” and “motion search” are synonymous.

Motion estimation may be obtained by calculating the similarity or difference between two similarly placed regions in the previous and current video frames. To calculate the difference, the sum of absolute differences (SAD) may be used. The result of the SAD is often called “distortion”, as it measures how different two areas of the previous and current frames are. Distortion may be computed as:

$$distortion = \sum \vert previous ( {x}_{1} , {y}_{1} ) - current ( {x}_{2} , {y}_{2} ) \vert \qquad ( 1 )$$

where, previous(x₁,y₁) is the location of a previous frame of video and current(x₂,y₂) is the location of a current frame of video. The idea behind calculating a distortion is to find a minimum distortion that will indicate the motion vector for a given macroblock. In rate-distortion, not only is the similarity in the picture regions considered, but also how large of a vector the motion has, i.e., how far an object has traveled. This vector must be stored, and therefore is a cost that must be considered. For this reason, motion estimation is usually performed by a motion search for many nearby locations (i.e., the motion vector is not too long). The optimal solution is found by comparing the rate-distortions of all possible choices.

It is also possible to predict motion from frame to frame. “Motion prediction” takes into consideration macroblocks for which a motion search has already been performed. Using motion prediction, it is possible to predict, within some margin of error, the motion of the current macroblock from the previous macroblock. This predicted motion is a vector, or “predicted motion vector.” To save memory storage and to get better compression, the difference between the actual motion vector and the prediction motion vector is stored. A conventional method of finding the predicted motion vector is to find the median for each component of the vectors of the surrounding, already motion searched macroblocks.

Video frame pixels form a two-dimensional (2D) grid, where the top left-hand corner is defined as the macroblock origin (0, 0). The positive x-axis is to the right and the positive y-axis is down, relative to the origin. The “location” of a macroblock is the location of the pixel in the top left-hand corner of the 16×16 macroblock. For example, consider a macroblock that is one macroblock to the right and one macroblock down. Its location is (16, 16). If that particular macroblock has a motion vector of (−2, −1), then that particular macroblock has moved from location (14, 15) in the previous frame to (16, 16) in the current frame. Motion searching is performed by trying different pixel locations which may specify where the macroblock in the current frame has moved from the previous frame. It is common to have motion searching begin at the macroblock origin.

One conventional motion search is referred to as an “exhaustive motion search”. Ordinarily in an exhaustive motion search, the field of possible movement for a given macroblock is limited to +/−16 pixels in the vertical and horizontal directions. This corresponds to 33×33 possible locations that must be investigated (or searched) for each macroblock. For this reason, the exhaustive motion search requires substantial computation and limits the speed at which succeeding video frames may be rendered.

Another conventional motion search is known as the “diamond motion search”, which is defined by the International Organization for Standardization, Coding of Moving Pictures and Audio: N3324, March 2000, also known as Predictive Motion Adaptive Field Adaptive Search Technique (PMVFAST), the contents of which are expressly incorporated herein by reference for all purposes. The conventional diamond motion search is based on logical rules that attempt to accomplish high quality motion searching without actually performing an exhaustive search. The basic idea behind the conventional diamond motion search is that objects will usually travel a very short, or no, distance from frame to frame. Therefore, one should search nearby locations first. If the best location found so far is on the edge of the range presently searched, then search a little further out. The search continues as long as a better location is found. If a better location cannot be found, then the search terminates. More precisely, the iterative process is continued until the best location found is not on the edge of the search range, i.e., the best motion vector for a macroblock appears to have been located. Another aspect of the diamond motion search is to use motion search seeding, i.e., choosing a preferred starting location for the motion search. In the case of the conventional diamond motion search, motion search seeding includes evaluating a few pixel locations and selecting the best one as the starting location.

The conventional diamond motion search has been proven effective at speeding up compression of motion video while causing very little quality impact relative to an exhaustive motion search. However, the conventional diamond motion search is susceptible to finding local minima. Additionally, the diamond motion search is very poor for compressing some content, e.g., “disjoint motion content” and “extreme high action content.” Disjoint motion content occurs when one macroblock has moved one direction, while the contents of an adjacent macroblock have moved a completely different direction. Extreme high action content occurs when content of a video frame has moved long distances.

Thus, there still exists a need in the art for a method and system for improved diamond motion searching that addresses the above problems associated with conventional diamond motion searching techniques.

### SUMMARY OF THE INVENTION

The present invention includes a method and system for improved diamond motion search. A method for diamond motion searching a video frame is disclosed which includes predicting the maximum distance that a macroblock may have moved. This maximum distance provides a maximum range in which to consider searching. This “predicted search range” may be used to make assumptions on whether to expect high motion. If high motion is anticipated, the diamond search may be seeded using a large circular pattern for determining a start location and to avoid becoming lost in local minima and then proceeding with the large diamond pattern for motion searching. A method for compressing motion video images is also disclosed. Additionally, a system for transmitting and receiving video images is disclosed. The system for transmitting and receiving video images may be a video conferencing system.

These embodiments of the present invention will be readily understood by one of ordinary skill in the art by reading the following detailed description in conjunction with the accompanying figures of the drawings.

### DESCRIPTION OF THE DRAWINGS

The drawings illustrate various views and embodiments for carrying out the present invention. Additionally, like reference numerals refer to like parts in different views or embodiments of the drawings.

FIG. 1 is a block diagram illustrating motion searching of a video frame.

FIGS. 2A and 2B are diagrams illustrating small and large diamond patterns in accordance with the conventional diamond motion search.

FIG. 3 is a flow chart of a method for motion searching a video frame in accordance with the present invention.

FIG. 4 is a diagram illustrating a presently preferred pattern of search locations for seeding a motion search under high motion conditions.

FIG. 5 is a block diagram of a system for compressing and decompressing images in accordance with the present invention.

### DETAILED DESCRIPTION OF THE INVENTION

The present invention includes a method and system for improved diamond motion searching. The method and system for improved diamond motion searching may be used to compress motion video images. In the following detailed description, for purposes of explanation, specific details are set forth in order to provide a thorough understanding of the present invention. It will be evident, however, to one of ordinary skill in the art that the present invention may be practiced without these specific details.

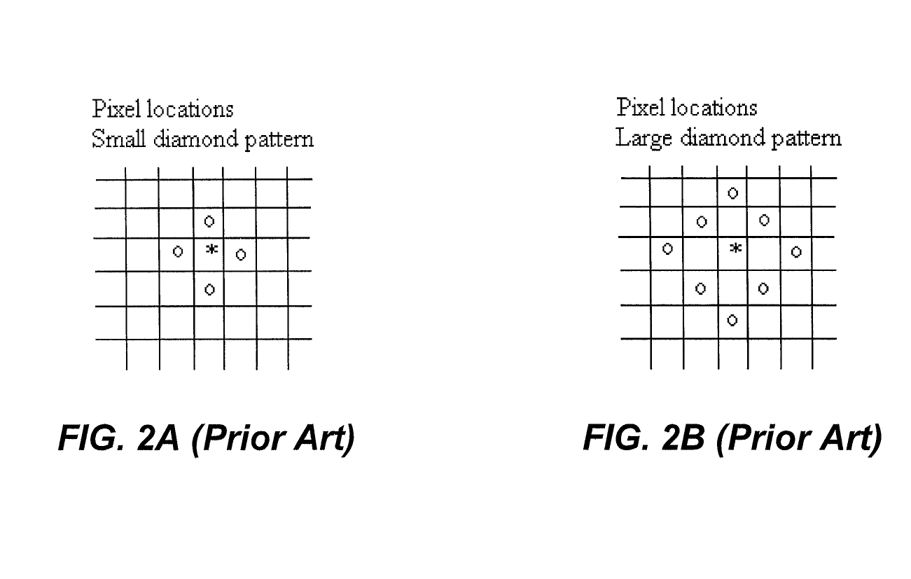

FIGS. 2A and 2B are diagrams illustrating small and large diamond search patterns, respectively, in accordance with the conventional diamond motion search. In FIGS. 2A and 2B, the symbol “*” is the current pixel location, and the symbols “o” are the pixel locations to search.

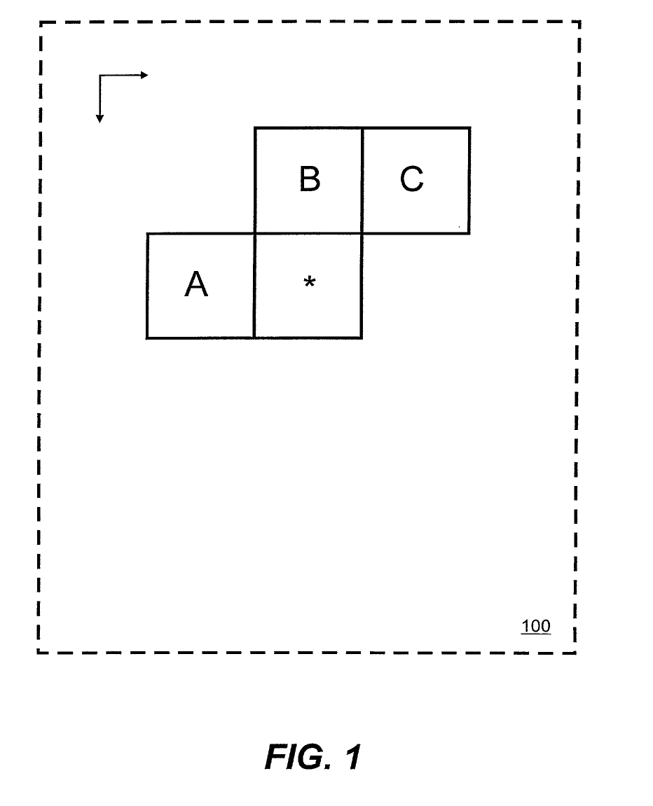

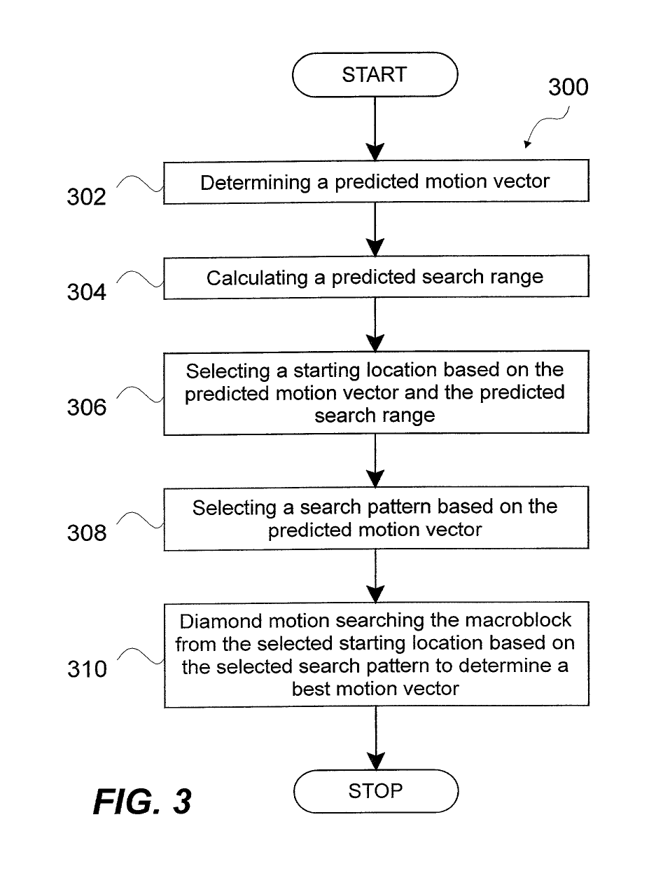

FIG. 3 is a flow chart of a method 300 of diamond motion searching in accordance with the present invention. Method 300 may include determining 302 a predicted motion vector. Determining 302 a predicted motion vector may include finding a median for each component of motion vectors for selected surrounding already motion-searched macroblocks. FIG. 1 is a block diagram illustrating motion searching of a video frame 100. The size of the video frame is not crucial to the invention. Motion searching is performed macroblock by macroblock from the upper left hand corner to the lower right hand corner of a video frame. The first row is searched first moving from left to right along rows before moving down to the second row. The arrows indicate search directions in FIG. 1. The preferred surrounding already motion-searched macroblocks include the left “A”, upper “B” and upper right “C” macroblocks relative to the current macroblock “*”, see FIG. 1. As macroblocks A, B and C will already have been searched, their motion vectors are known when the current macroblock “*” is searched. For macroblocks on borders of a video frame, i.e., top, right and left borders, there are assumptions defined for specifying the motion vectors for neighboring macroblocks, that are known to one of ordinary skill in the art.

Method 300 may further include calculating 304 a predicted search range. The predicted search range is a maximum distance that the current macroblock could have moved away from the predicted motion vector. The predicted search range may be determined by considering the motion that has taken place in the surrounding or adjacent macroblocks that have already been motion-searched, e.g., A, B and C of FIG. 1. The greater the difference in motion between nearby macroblocks, the greater the chance of the current macroblock experiencing high local motion. An exemplary method of calculating 304 the predicted search range may include finding the maximum per-component difference of the motion vectors of the surrounding, already motion-searched macroblocks (A, B and C of FIG. 1). This maximum per-component difference may be multiplied by a scale factor, e.g., 2, to ensure that predicted search range is large enough. Suitable scale factors may range from 1.0 to 4.0. The predicted search range may be used as a limit or threshold for motion searching in accordance with the present invention. The use of other methods of calculating 304 a predicted search range are consistent with the present invention.

Method 300 may further include selecting 306 a starting location based on the predicted motion vector and the predicted search range. Selecting 306 a starting location may vary depending on the predicted search range. The predicted search range may be small or large, as defined, for example, by an integer threshold, m. For example and not by way of limitation, if the predicted search range is less than an integer threshold, m=8, then a starting location may be selected by testing locations pointed to by three surrounding, already motion-searched macroblocks and selecting one of the tested locations having a lowest distortion. Distortion may be calculated by any suitable method such as, for example, SAD, as shown in Eq. (1) above, or a rate-distortion calculation, see Eq. (2) below.

If, for example, the predicted search range is greater than or equal to the integer threshold, m=8, then a starting location may be selected by searching an integer number, j, of locations located approximately r pixels from an initial search center in a radial pattern and approximately equidistant from one another along a circumference of a circle of radius r, if a predicted search range is greater than or equal to an integer p and selecting a best location from among said integer number j of locations. The initial search center may be a macroblock origin. The integer number j of locations may be an integer from 5-10 inclusive. The radius r pixels may be measured in “city blocks”, where each pixel of a video frame is located at an intersection of a grid, each square of the grid denoting a city block, or by any other suitable measure. A presently preferred measure for r is 8 pixels. Other suitable values for radius r are also contemplated to be within the scope of the present invention.

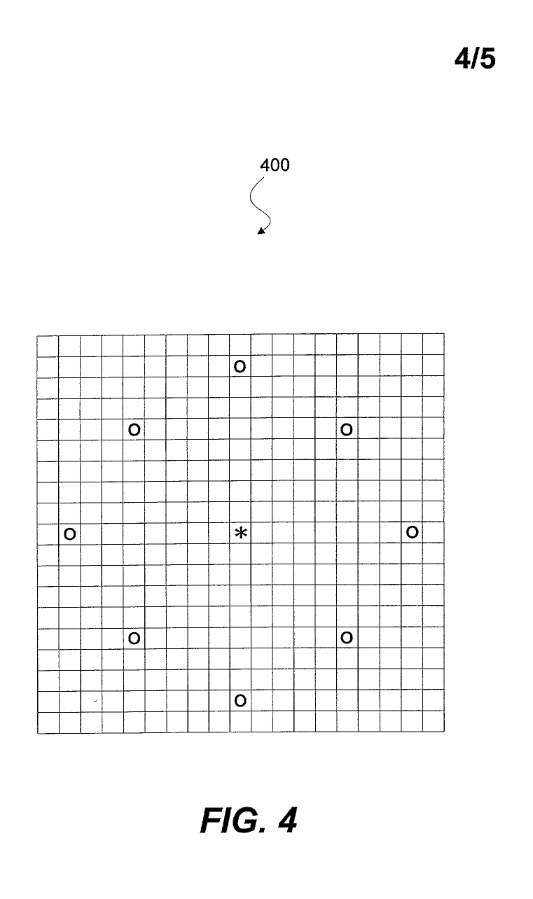

FIG. 4 is a diagram illustrating a presently preferred pattern of search locations for seeding the motion search under high motion conditions, i.e., selecting 306 a starting location, when the predicted search range is large. In FIG. 4, the “*” symbol represents the initial search center, which may be the macroblock origin or some other location. The “o” symbols represent locations to be tested for determining the best starting location. All 8 locations are evaluated and the best is selected as the starting point or search center for the subsequent searching. Using a broad pattern to determine a best search center overcomes the local minima problem of the conventional diamond search method. In the traditional diamond search (PMVFAST), seeding is only performed when the motion vectors of the surrounding, already motion-searched macroblocks are slightly long, and only performed at the locations indicated by those 3 motion vectors. However, that is not enough seeding for very high motion cases. Thus, according to the present invention, if it appears that there may be a lot of motion based on the motion vectors of the surrounding, already motion-searched macroblocks, then the current macroblock will probably experience a lot of motion as well. Under this circumstance, it is usually beneficial to seed the motion search, i.e., find a new starting location, in accordance with the present invention.

Returning to FIG. 3, method 300 may further include selecting 308 a search pattern based on the predicted motion vector and diamond motion searching 310 the macroblock for the selected starting location based on the selected search pattern to determine a best motion vector. Selecting 308 a search pattern may include selecting a small diamond search pattern (FIG. 2A) if the predicted motion vector is less than or equal to a distance of 1 pixels and selecting a large diamond search pattern (FIG. 2b) if the predicted motion vector is greater than a distance of 1 pixels. Distance 1 pixels may be in the range of 2 to 4.

From a selected search center, conventional diamond motion searching may include the following steps: (1) search around the current location using the selected diamond pattern. For each location a distortion is calculated; (2) if there is a location with a lower distortion than the current location, move there and search again, i.e., go to step 1. Otherwise, end searching, i.e., go to step 3; (3) if the large diamond pattern (see FIG. 2B) was initially selected and used during the subsequent searches, perform one final search with the small diamond pattern (see FIG. 2A) for final refinement. Note that the small diamond pattern fits snugly inside the large diamond pattern.

In accordance with the present invention, rate-distortion (RD) may be calculated as follows:

RD n(rate)+m(distortion) (2)

where n and m are scalar values used for weighting rate and distortion. Selection of the scalar values, n and m, is within the knowledge of one of ordinary skill in the art and, thus, will not be further elaborated. The rate is the number of bits of storage required for macroblock overhead, such as motion vectors. In other words, rate is a measure of non-pictorial information that must be sent along with the portion of the image that has changed. For example, a macroblock usually has a few pieces of information associated with it: (1) the macroblock type and (2) motion vectors. This information is extra overhead, above and beyond whatever pictorial information must be stored.

The idea behind calculating a RD is to measure the overall predicted cost of storage when taking both of these factors (rate and distortion) into account. The inventive block size heuristic is not dependent on the particular measure of rate or distortion or the RD formed by a linear combination of rate or distortion. A rate is a measure of non-pictorial information overhead. A particular measure of rate may be defined as a number of bits of storage required for macroblock overhead. Other measures of rate may be suitable in accordance with the present invention

Distortion is an approximation of how much pictorial information must be stored. For example, as more of the picture information in the current differs from the previous video frame, more picture information must be stored. The goal of the motion search is to find the motion vectors and block size that minimizes the RD for each macroblock as applied to the current video frame. There are many measures of distortion known in the art. A preferred measure of distortion in accordance with the present invention is a sum of absolute differences, as defined in Eq. (1) above. However, any suitable measure of distortion may be used with the method and system of the present invention.

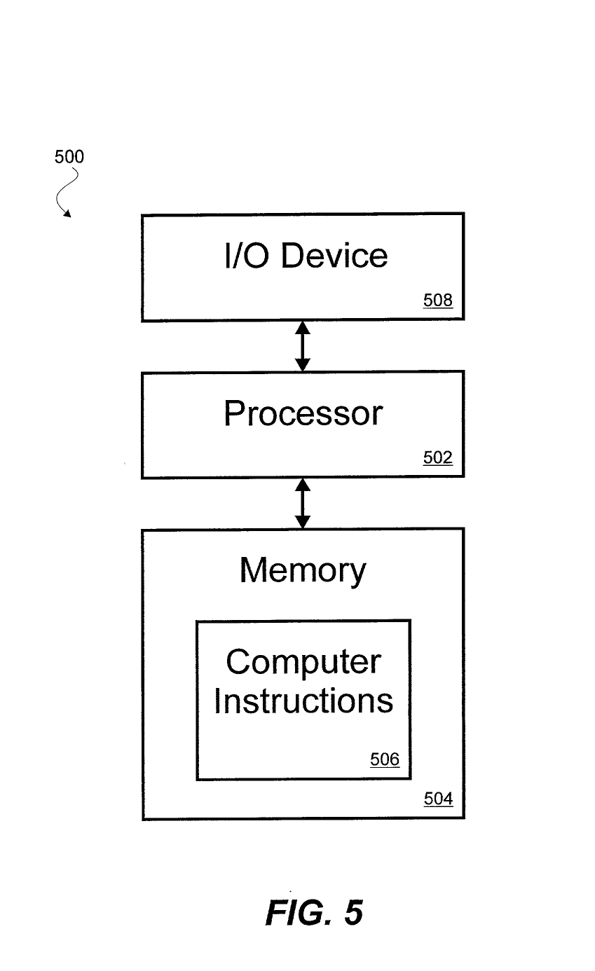

FIG. 5 is a block diagram of a system 500 for compressing and decompressing images in accordance with the present invention. System 500 may be configured to implement method 300. System 500 may be configured for transmitting and receiving video images. System 500 may be a video conferencing system, for example and not by way of limitation, SORENSON VIDEO 3™, available from Sorenson Media, 4393 South Riverboat Road, Suite 300, Salt Lake City, Utah 84123. System 500 may be configured for communication over a network (not shown for clarity). System 500 may include a processor 502 configured for processing computer instructions 506 and a memory 504 for storing computer instructions 506.

Computer instructions 506 may be in the form of a computer program. System 500 may include computer instructions 506 implementing a method for compressing motion video images. The method may be method 300 as described above. The method may include inputting a video frame, performing a motion search on the video frame, computing the change between the video frame and a previous video frame not taking into account motion vector for each block in the video frame and the computed change.

Although this invention has been described with reference to particular embodiments, the invention is not limited to these described embodiments. Rather, the invention is limited only by the appended claims, which include within their scope all equivalent devices or methods that operate according to the principles of the invention as described herein.

What is claimed is:

1. A method for predicting a search range for use in selecting a search center in motion video motion searching, comprising:
determining a maximum per-component difference of motion vectors of surrounding, already searched macroblocks; and
multiplying said maximum per-component difference by a number n to ensure said predicted range is large enough.

2. The method according to claim 1, wherein said number n equals 2.

3. A method for selecting a search center in motion video motion searching, comprising:
searching an integer number j of locations located approximately r pixels from an initial search center in a radial pattern and approximately equidistant from one another along a circumference of a circle of radius r, if a predicted search range is greater than or equal to an integer p; and
selecting a best location from among said integer number j locations.

4. The method according to claim 3, wherein said integer number j comprises a number selected from the group consisting of 5, 6, 7, 8, 9 and 10.

5. The method according to claim 3, wherein said integer number j equals 8.

6. The method according to claim 3, wherein said radius r comprises approximately 8 pixels.

7. The method according to claim 3, wherein said integer number p equals 8.

8. A method of motion searching a macroblock, comprising:
determining a predicted motion vector;
calculating a predicted search range;
selecting a starting location based on said predicted motion vector and said predicted search range;
selecting a search pattern based on said predicted motion vector; and
diamond motion searching said macroblock from said selected starting location based on said selected search pattern to determine a best motion vector.

9. The method according to claim 8, wherein said determining a predicted motion vector comprises finding a median for each component of motion vectors for three surrounding, already motion-searched macroblocks.

10. The method according to claim 8, wherein said calculating a predicted search range comprises determining a maximum difference for each component of motion vectors for three surrounding, already motion-searched macroblocks.

11. The method according to claim 10, further comprising doubling said maximum difference.

12. The method according to claim 8, wherein said selecting a starting location comprises:
if said predicted search range is less than an integer threshold m, then:
testing locations pointed to by three surrounding, already motion-searched macroblocks; and
selecting one of said locations having a lowest distortion as said starting location;
if said predicted search range is greater than or equal to said integer threshold m, then:
searching an integer number j of locations located approximately r pixels from an initial search center in a radial pattern and approximately equidistant from one another along a circumference of a circle of radius r, if a predicted search range is greater than or equal to an integer p; and
selecting a best location from among said integer number j locations.

13. The method according to claim 12, wherein said integer threshold m equals 8.

14. The method according to claim 12, wherein said integer number j comprises a number selected from the group consisting of 5, 6, 7, 8, 9 and 10.

15. The method according to claim 12, wherein said integer number j equals 8.

16. The method according to claim 12, wherein said radius r comprises approximately 8 pixels.

17. The method according to claim 12, wherein said integer number p equals 8.

18. The method according to claim 8, wherein said selecting a search pattern comprises:
selecting a small diamond search pattern if said predicted motion vector is less than or equal to a distance of 1 pixels; and
selecting a large diamond search pattern if said predicted motion vector is greater than said distance of 1 pixels.

19. The method according to claim 18, wherein said distance of 1 pixels comprises a distance of 2 pixels.

20. A method for compressing motion video images comprising:
inputting a video frame;
performing a motion search on each macroblock of said video frame comprising:
determining a predicted motion vector;
calculating a predicted search range;
selecting a starting location based on said predicted motion vector and said predicted search range;
selecting a search pattern based on said predicted motion vector and said predicted search range; and
motion searching said macroblock from said starting location based on said search pattern to determine a best motion vector;
storing a motion vector for each block in said video frame; and
residual coding of motion compensated errors.

21. The method of claim 20, further comprising repeating all steps for a subsequent video frame.

22. A system for transmitting and receiving video images, comprising:
computer instructions;
a processor configured for processing said computer instructions; and
a memory for storing said computer instructions;
wherein said computer instructions implement a method for compressing motion video images, said method comprising:
inputting a video frame;
performing a motion search on each macroblock of said video frame comprising:
determining a predicted motion vector;
calculating a predicted search range;
selecting a starting location based on said predicted motion vector and said predicted search range;
selecting a search pattern based on said predicted motion vector and said predicted search range; and
motion searching said macroblock from said starting location based on said search pattern to determine a best motion vector; and
storing a motion vector for each block in said video frame.

23. The system of claim 22, further comprising an input device in communication with said processor for capturing video images.

24. The system of claim 22, wherein said system is further configured to communicate over a network.
